(19) United States
(12) Patent Application Publication
(10) Pub. No.: US 2026/0346413 A1
(43) Pub. Date: Nov. 5, 2026

(54) Method and Device for Controlling the Tightening Tension of an Aeronautical Fastener

(71) Applicant: LISI AEROSPACE, Paris (FR)

(72) Inventors: Benoit REGNARD, Les Clayes Sous Bois (FR); Clément ROUSSEAU, Osny (FR); Florent DELAGE, Clamart (FR); Christophe PAYARD, Rueil-Malmaison (FR); Martial BROUCKE, Delincourt (FR)

(73) Assignee: LISI AEROSPACE, Paris (FR)

(21) Appl. No.: 19/123,607

(22) PCT Filed: Nov. 22, 2023
(86) PCT No.: PCT/EP2023/082638

§ 371 Date: Apr. 23, 2025

(30) Foreign Application Priority Data
Nov. 24, 2022 (FR) FR2212289

(51) Int. Cl. B25B 23/147; F16B 31/02

(52) U.S. Cl. CPC B25B 23/147; F16B 31/02; F16B 2031/022

(57) ABSTRACT

The invention relates to a method for tightening a fastener (30), comprising the following steps:
supply of a screw (32) comprising a head (322), a threaded portion (324) and a recess (326);
inserting the screw into a hole (20) and inserting a nut (34) on the threaded portion;
engaging a bit (76) in the recess, until contact with the bottom;
Rotating the nut by rotating the bit and screw;
excitation of an ultrasonic transducer (88) arranged on the bit;
Reception and processing of ultrasonic waves reflected from a front surface of the screw head, to calculate a tension in the screw;
Stopping the rotation of the nut when the said tension equals a predefined threshold.

### TECHNICAL FIELD OF THE INVENTION

The present invention relates to a method for controlling the tightening tension of a fastener as well as a device for such control, in particular for the aeronautical industry.

### TECHNICAL PRIOR ART

It is known from the technique that to secure two elements together, e.g. structural elements of an aircraft, these elements include aligned holes for mounting fasteners that secure the elements by clamping them axially against each other.

In this application, fastener means a set consisting of a screw and a nut. In the aerospace industry, the nut must be tightened to a torque predetermined by calculation when the fastener is designed to ensure that the elements are tightened and that they are not accidentally detached during operation.

Suitable fasteners for such use are, for example, HI-LOK™ fasteners as described in the U.S. Pat. No. 3,138,987A patent or HI-LITE™ screws as described in the U.S. Pat. No. 4,326,825A patent. An example of a HI-LITE™ fastener is shown in FIGS. 1A and 1B.

The HI-LITE ™ fastener includes a screw 10, featuring a protruding head 12, a smooth shank 14, and a threaded end 16. The threaded end 16 includes a hexagonal drive 18. Screw 10 is installed in a hole 20 made in the first 22 and second 24 elements until the head 12 rests on a front face 26 of the first element 22. Nut 30 is screwed onto threaded end 16 emerging from the rear face 28 of the second element, opposite face 28, the screw being secured by a wrench or bit (not shown) inserted into hex recess 18, until the nut contacts face 28. The nut includes a break groove 31 designed to break at a predetermined torque, providing a tension, or preload, in the screw 10 necessary to withstand the shear and tensile stresses exerted by elements 22, 24 on screw 10.

This assembly solution is widely used and is very efficient, but it does not make it possible to verify, once the nut is installed on the screw, that the installed tension does not vary over time.

When a conventional nut, without a breaking groove, is used, the tightening is usually carried out by means of a torque wrench with a predetermined torque. Even if the torque is well controlled by using a wrench, the tolerances of geometry, surface finish and lubrication inevitably lead to a large dispersion of the actual preload installed, which can lead to a risk of head or thread breakage, or on the contrary, tightening at a preload lower than the desired preload.

Direct measurement of tension, i.e. the tensile force applied to the screw and the compressive force applied to the held elements, is not possible. There are fasteners with one or more strain gauges, or an ultrasonic transducer, that can indirectly measure the tension of the screw during or after tightening the nut. Gauges or transducers should be positioned on the fastener and electrically powered. This solution therefore requires the instrumentation of each fastener, which significantly increases its price. In addition, the addition of components increases the weight of the fastener, which limits their use in large quantities on an aircraft since several tens of thousands of fasteners are installed on an aircraft. In addition, the resistance of electronic components to temperature variations, environmental conditions and paint does not allow all fasteners to be instrumented and represents a difficulty in qualification. Adding electrical contacts to the terminals of the gauges or transducers cannot also be done on all fasteners, since these terminals must be accessible.

Current technology therefore does not allow for the installation of a fastener at a predetermined tension in industrial operation and for repeated and reliable monitoring of this tension.

### SUMMARY OF THE INVENTION

The present invention is intended to remedy these drawbacks and relates to a simple and effective control method and a centering device for its implementation.

The invention thus proposes a method for tightening at least one fastener, comprising a screw and a nut, the screw comprising: a head having a flat front surface; a threaded portion; and a recess, comprising a flat bottom and a non-circular section; and a nut including a drive surface; the method comprising the following steps: (a) inserting the screw into a hole through at least two elements until one end of the threaded portion emerges from the elements, and placing the nut on the emergent end of the threaded portion of the screw; (b) engaging an immobilizer bit in the recess, until a front face of the end bit contacts the flat bottom of said recess, said immobilizing bit comprising a complementary shape of the non-circular section of said recess; (c) rotating the nut on the threaded portion of the screw while rotating the immobilizer bit and screw; excitation of an ultrasonic transducer arranged on a rear side of the bit, the ultrasonic transducer being capable of generating ultrasonic waves in the bit and screw when the bit is engaged in the screw recess; Reception of the ultrasonic waves reflected from the flat front surface of the screw head and processing of the received ultrasonic waves to calculate a tension in the screw; Stopping the rotation of the nut when the tension in the calculated screw equals a predefined threshold tension.

Thus, thanks to the invention, it is ensured that the fastener is installed at the required tension, without the fastener having any transducer or sensor on board.

The method according to the invention may comprise one or more of the following features, taken in isolation from each other or in combination with each other
at the step of engaging the bit in the screw recess, the immobilizer bit is engaged with a predetermined pressure on the screw via at least one elastic device;
the nut is rotated by a socket and, after step (b) and before step (c), a stress is applied to the nut to limit an axial relative movement of the nut with respect to the socket, a resultant of said stress axially opposing the pressure imparted on the screw by the immobilizer bit;
a dry couplant is inserted between the front of the bit and the flat bottom of the recess prior to the excitation of the transducer;
A liquid couplant or gel is poured into the recess prior to excitation of the transducer.

The present invention also relates to a tightening device allowing the implementation of a tightening method as described above, of a screw in a hole passing through at least two elements, the screw comprising: a head having a flat front surface; and a threaded portion; an end of said threaded portion having an axially arranged recess, said recess comprising a flat bottom and a non-circular section; the tightening device comprising: a body; and a fixed immobilizing bit rotating and axially movable with respect to the body, the bit comprising: an anti-rotation interface configured to engage with the non-circular section of the screw recess; a flat front face, configured to contact the flat bottom of the recess; and an opposite back side. The tightening device also includes: a movable socket rotating with respect to the body and configured to drive the nut in rotation; an ultrasonic emitter, arranged on the back side of the bit, the ultrasonic emitter being capable of generating ultrasonic waves in the bit and in the screw when the front face of the bit is in contact with the flat bottom of the screw recess; and an ultrasonic receiver, arranged on the back side of the bit, the ultrasound receiver being able to convert a reflected ultrasonic wave into an electrical signal.

The device used allows fasteners to be installed at the desired tension in a uniform manner, which ensures reliability and increased repeatability of the tightening tension in the assembly.

The tightening device according to the invention may comprise one or more of the following features, taken in isolation from each other or in combination with each other:
the immobilizer bit comprises a cavity with a flat bottom, the ultrasound receiver being placed on the said flat bottom;
the bit has a density identical to or close to the density of the screw;
the bit includes a tin deposit on the front side;
the tightening device also includes an immobilizer support, said support comprising: a fixed part in relation to the body; and a movable part, capable of sliding axially inside the fixed part; the ultrasonic transmitter and receiver and the immobilizer bit being integral to said movable part;
the tightening device comprises a compression spring arranged in the immobilizer support, the spring resting on the movable part on the one hand and on the fixed part of the immobilizer support on the other;
the nut includes an axial stop; and the tightening device comprises a counter-stop device cooperating with the axial stop of the nut, the axial stop and the counter-stop device being capable of limiting a relative axial movement between the nut and the tightening device;—the axial stop of the nut comprises at least a hollowed portion with respect to an external surface of the nut, and the counter-stop device comprises at least one radially movable blocking element, said at least blocking element being adapted to fit into said at least hollowed portion of the nut;
the axial stop of the nut includes at least one portion of groove or at least one cut-out;
the counter-stop device also comprises: a first flange disposed at a free end of the flange, said first flange having at least one notch extending radially into a thickness of the first flange; a ring arranged around the socket, said ring being free in rotation around the socket and fixed in translation with respect to the socket, said ring comprising a second flange resting against the first flange, a radial surface of said second flange being provided with a helical groove; and at least one movable element capable of sliding in the at least one notch of the first flange, a radial surface of the notch being provided with at least one curved groove capable of cooperating with the helical groove of the second flange, an internal peripheral surface of the movable element being capable of cooperating with the negative portion of the nut;
the socket includes at least one radial through hole; the tightening device also including a ring arranged around the socket; the at least one blocking element being movable in at least one radial hole between a protruding position inside the socket, and a retracted position in which at least one blocking member does not interfere with the insertion of the nut into the socket;
the ring has a first internal surface capable of sliding axially along the socket, the internal surface comprising a first circumferential groove, at least one blocking element being contained in the first circumferential groove of the ring in the retracted position;
the ring has an internal shoulder, the tightening device comprising an elastic element housed in a space between the socket and the ring, said spring resting on the one hand against the inner shoulder of the ring and on the other hand against an outer shoulder of the socket;
the ring is provided with at least one radially flexible tab extending axially, said tab being provided at one end with a protrusion capable of penetrating the at least one hole in the socket;
the tightening device further comprises a second ring arranged around the ring, the second ring comprising a tubular portion pierced with at least one hole, each hole being configured to receive at least the protrusion of one tab, the second ring being capable of sliding axially over the ring, and being configured so that an axial movement towards a second end of the ring causes a radial outward displacement of each protrusion;
the nut comprises at least one stop extending radially outwards, the counter-stop device comprising a ring disposed around the socket, said ring comprising at least one counter-stop, said stops and counter-stops being configured so that a relative rotation of the ring with respect to the nut opposes axially said stops and counter-stops.

### BRIEF DESCRIPTION OF THE FIGURES

Other features and advantages of the invention will become apparent in the course of the following detailed description, for the understanding of which reference is made to the annexed drawings in which:

FIG. 1A is a side view of a fastener of the prior art;

FIG. 1B is a side-view and cross-sectional view of a prior art fastener installed in a structure;

FIG. 2 is a side view of a fastener suitable for use in a tightening process according to a method of embodiment of the invention;

FIG. 3 is a schematic cross-sectional view of a tightening device according to a method of embodiment of the invention and of the fastener of FIG. 2, in a first step of a method of tightening according to a mode of embodiment of the invention;

FIG. 3A is a longitudinal section of an immobilizer bit according to a method of embodiment of the invention;

FIG. 4 is a view similar to FIG. 3 in a second step of the said tightening process;

FIG. 5 is a view similar to FIGS. 3 and 4 in a third step of the said tightening process; and

FIG. 6 is a block diagram illustrating the steps of a method of carrying out the method of tightening the fastener of FIG. 2 by means of the tightening device of FIGS. 3, 4 and 5,

FIGS. 7a, 7b, 7c, 7d FIGS. 7a, 7b, 7c and 7d are isometric views of nuts suitable for use in a tightening process according to a method of embodiment of the invention,

FIGS. 8a, 8b, 8c FIGS. 8a, 8b and 8c are partial isometric views of a tightening device according to a first embodiment of the invention,

FIG. 9a is a partial isometric view of a socket used in a tightening device according to a second embodiment of the invention,

FIG. 9b is a cross-sectional view of a tightening device according to a second embodiment of the invention, with the socket in FIG. 9a and the nut in FIG. 7b,

FIG. 10a is a partial isometric view of a part of a tightening device according to a third embodiment of the invention,

FIG. 10b is a partial isometric view of a ring used in the tightening device according to the third embodiment of the invention,

FIG. 10c is a cross-sectional view of the tightening device according to the third embodiment of the invention, with the nut of FIG. 7c,

FIG. 11a is a partial isometric view of a tightening device according to a fourth embodiment of the invention,

FIG. 11b is a front view of the tightening device in FIG. 11a, with the nut in FIG. 7D.

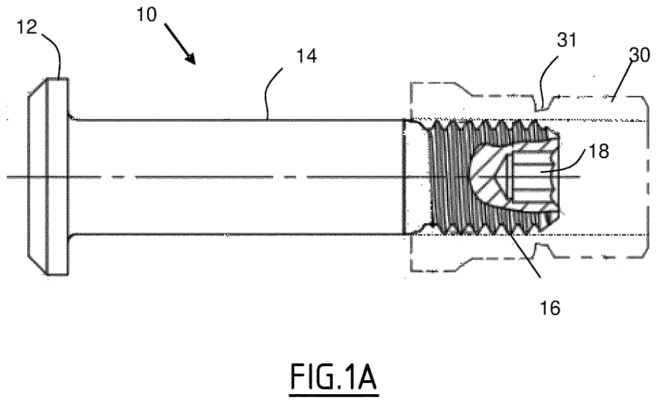

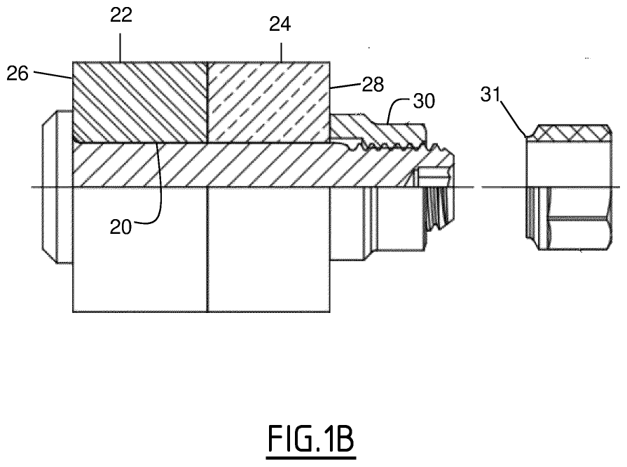

### DETAILED DESCRIPTION OF THE INVENTION

In the following description, the method and fastener tightening device are used to assemble aircraft structures.

However, this example is not exhaustive, as the method and tightening device are applicable to other types of assembly or application, such as fasteners joining land vehicle structures or wind turbine blades.

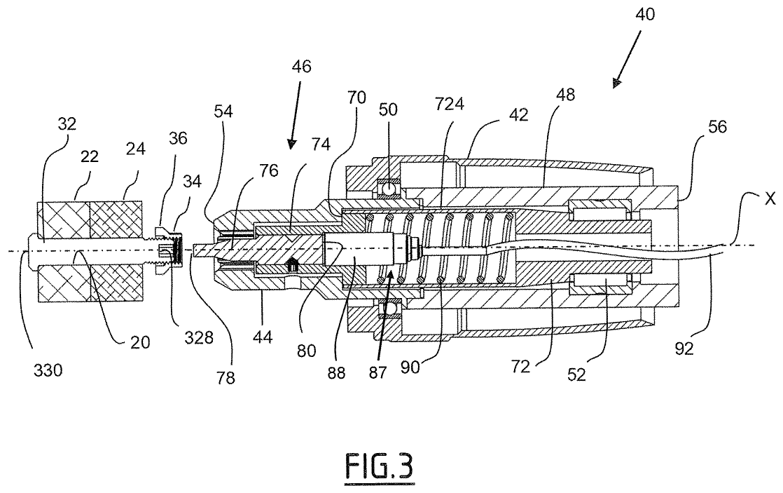

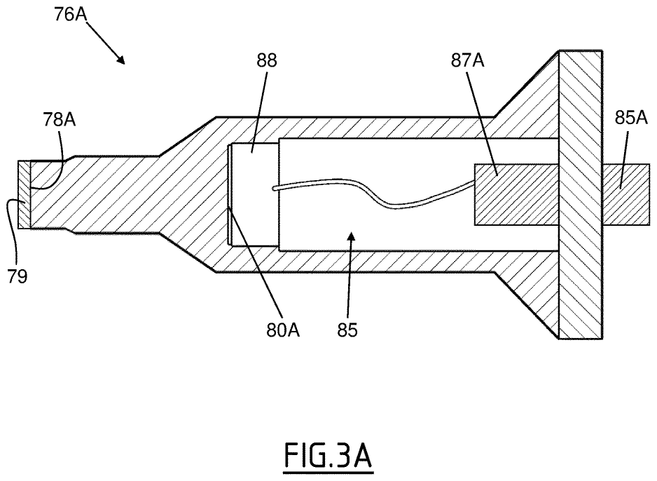

Reference is now made to FIGS. 3 to 5 which show a tightening device 40 configured to tighten a fastener, according to a method of embodiment of the invention.

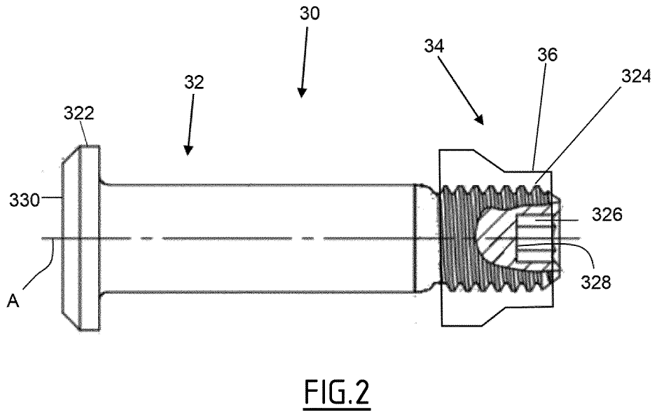

Said fastener, shown alone in FIG. 2, comprises a screw 32 and a nut 34. Screw 32 extends along an A-axis and includes a protruding head 322, a threaded portion 324 and a recess 326.

The recess 326 is arranged along the A-axis and opens on one end of the threaded portion 324, opposite the head 322. Transverse to the A-axis, the recess 326 has a non-circular cross-section.

In the embodiment depicted, the non-circular section is hexagonal in shape. Alternatively, the non-circular section of the recess is multilobed, e.g. as described in the applicant's patent FR2967735B1, or any other non-circular shape which makes it possible to block the rotation of screw 32 by the insertion of a key or a bit of complementary shape.

In contrast to screw 10 of the prior art, the bottom 328 of the recess is flat and parallel to the front surface 330 of head 322. Specifically, the bottom 328 of the recess and the front surface 330 of the head are perpendicular to the A-axis.

Preferably, the flat bottom 328 is obtained either by machining the bottom of the recess, previously carried out by broaching, or by electro-discharge rubbing, or by adding material to the recess with a conical base so as to obtain a flat bottom. Preferably, the addition of material has a density comparable to that of the screw so as not to scatter or diffract or disturb the course of the ultrasonic waves, as will be described later. Preferably, the roughness Ra of the flat bottom 328 is less than 2.

Apart from the modification of the recess bottom and the possible addition of a coupling agent, screw 32 is similar to screw 10 of the prior art described above. In particular, the screw 32 is devoid of any tension or bending sensor, transducer capable of emitting sound waves, ultrasound, or any electrical or electronic component such as batteries, capacitors or antennas.

The nut 34 includes 36 drive outer surfaces, e.g. six or twelve flat surfaces. A suitable nut is for example described in the applicant's patent EP2350473. The 34 nut is also devoid of any tension or bending sensor, transducer capable of emitting sound waves, ultrasound, or any electrical or electronic component such as batteries, capacitors or antennas.

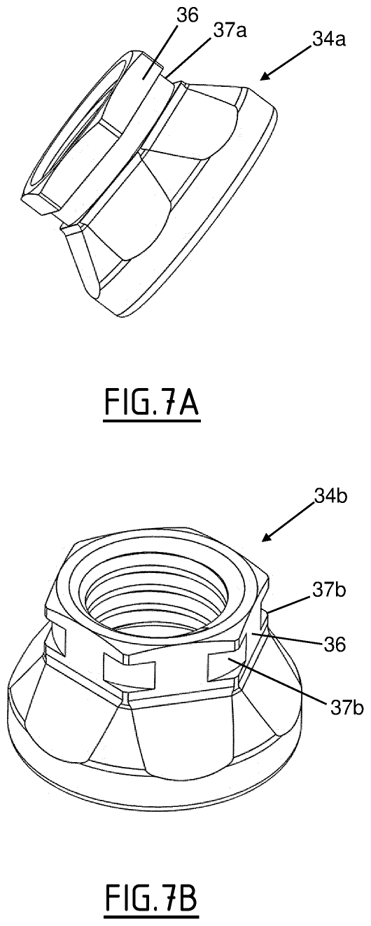

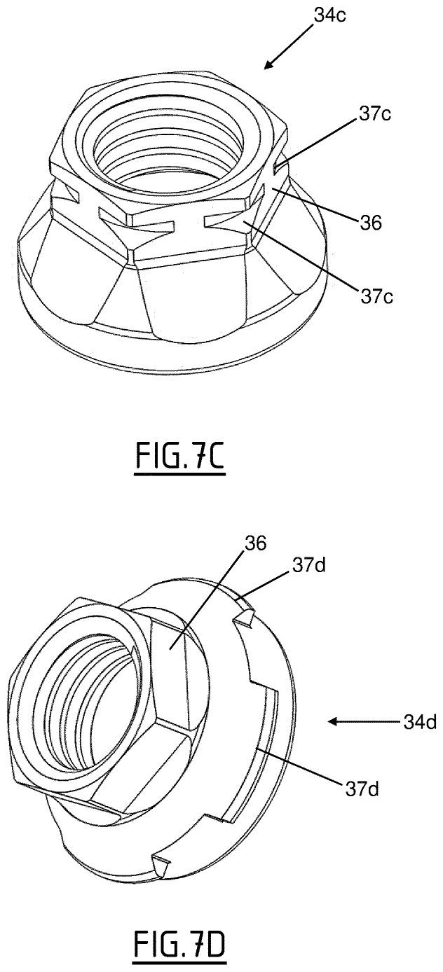

FIGS. 7, 7b, 7c and 7d show respectively nuts 34a, 34b, 34c and 34d comprising an axial stop capable of cooperating with a counter-stop device of the tightening device, the axial stop and the counter-stop device being able to limit a relative axial movement between the nut and the tightening device.

On nuts 34a, 34b and 34c, the axial stop is a portion in depression with respect to an external surface of the nut. More specifically, in the embodiments shown, the depression portion is made on nuts 34a, 34b and 34c respectively, by a circumferential groove 37a arranged between the base plate and the outer drive surfaces 36, a rectangular cut 37b made on each edge between two external drive surfaces 36, and a triangular-shaped cut 37c made on each edge between two external drive surfaces 36.

In the variant not shown, the depression portion is a circumferential groove made on the driving surfaces 36.

Cuts 37b and 37c may have different shapes than those shown in FIGS. 7b and 7c. For example, they can be circumferential groove portions. On the nut 34d, the axial stop consists of four projecting portions 37d, extending radially outward. Said projecting portions are arranged in this example at 90° on the base of the nut. The number of projecting portions 37d is not limited to four: the nut may be provided with one, two, three, or more projecting portions, uniformly or ununiformly arranged around the base. A uniform arrangement has the advantage of being more easily gripped by the tightening device, as will be explained below.

Regardless of the form of embodiment chosen to form the axial stop, the axial stop has a radially extending surface, outwards or inwards, capable of interacting with at least one radially extending surface, inwards or outwards, of a component of the tightening device suitable for cooperating with the nut, to limit a relative axial movement of the nut in relation to the tightening device. The axial stop is designed to resist tension and torsional break to preserve the structural integrity of the nut.

The tightening device 40 extends along an X-axis and consists of a tubular body 42, a socket 44 and an immobilizer support 46. The socket 44 is rotated in motion with respect to the body 42. In the embodiment shown, the tightening device also comprises a hollow drive shaft 48 attached to an axial end of the socket. The shaft 48 is configured to drive the socket 44 rotating around the X-axis.

In the embodiment shown, the tightening device also comprises ball bearings 50 and roller bearings 52. The ball bearings 50 are arranged radially between the socket 44 and the body 42, allowing the rotation of the socket relative to the body. The roller bearings 52 will be described below.

The socket 44 is hollowed out internally, the hollowed part forming an inner housing extending axially between a first end 54 and a second end 56 opposite, both ends being open.

The housing of the socket 44 comprises: a distal portion 60 near the first end 54, an intermediate portion 64 and a proximal portion 66 near the second end 56 (FIG. 5). The distal portion 60 has an inner diameter significantly smaller than the inner diameters of the intermediate 64 and proximal 66 portions. The intermediate portion 64 has a diameter significantly smaller than the inner diameter of the proximal portion 66.

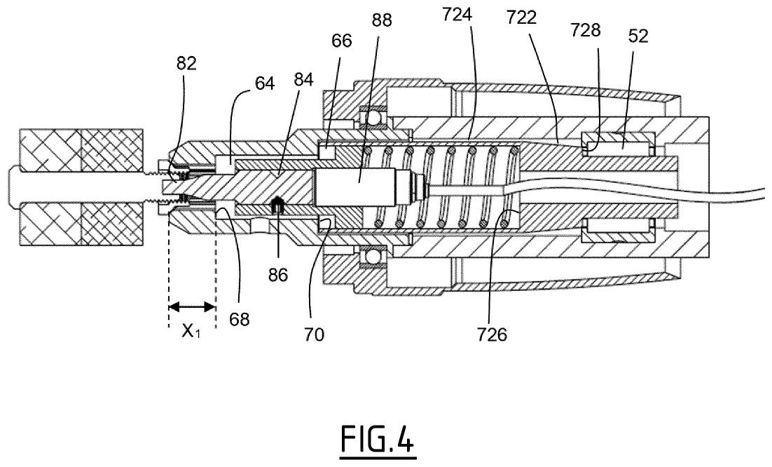

The junction of the distal portions 60 and intermediate portions 64 forms a first shoulder 68. The junction of the intermediate portion 64 and proximal portion 66 forms a second shoulder 70 (FIG. 4).

The distal portion 60 of the socket 44 is configured to receive the nut 34 and drive it in rotation. The inner peripheral wall of the distal portion 60 comprises at least two flat faces 62 intended to engage with at least two drive plane surfaces 36 of the nut 34. Preferably, the socket is adapted to the shape of the nut it is to drive, and has for example as many flat faces as drive surfaces 36 of the nut. An axial dimension X1 of the distal portion 60 is configured to fully accommodate the nut 34 and a protruding portion of the threaded portion 324 of the screw, when the nut is installed on the threaded portion and in contact with the rear surface 28 of the second element 24, as shown in FIG. 5.

The immobilizer support 46 consists of a fixed part 72 and a movable part 74. The fixed part 72 is fixed in relation to the body 42 in rotation and translation. The movable part is able to slide axially into the fixed part.

The fixed part 72 comprises a tubular portion 722 and a crown 724, adjacent on the X-axis. The tubular portion 722 is arranged in the hollow shaft 48. The roller bearings 52 are arranged radially between the tubular portion 722 and the shaft 48, allowing the rotation of the said shaft with respect to the fixed part 72 of the immobilizer support 46.

Crown 724 has a tubular shape. A first part of the crown 724 extends into the hollow shaft and a second part of the said crown extends into the proximal portion 66 of the socket 44. An external diameter of the crown 724 is less than an internal diameter of the proximal portion 66 of the socket 44. A free end of the crown is placed near the second shoulder 70. The junction between tubular portion 722 and crown 724 forms a countersink 726, so that the internal diameter of the crown is greater than the internal diameter of tubular portion 722.

The fixed part 72 also includes an annular surface 728 perpendicular to the X-axis, butting against the roller bearings 52. The fixed part is thus axially locked in the hollow shaft and the socket 44, between the second shoulder 70 of the socket 44 and the roller bearings 52, with a small axial clearance.

The movable part 74 has a collar 742 and a skirt 744 extending axially from the flange. The external diameter of the 742 flange is greater than the external diameter of the 744 skirt.

The flange 742 is housed in the second part of the crown 724, which is itself housed in the proximal portion 66 of the socket 44. The external diameter of the flange 742 is smaller than the internal diameter of the crown 724, with sufficient clearance for the movable part 74 to move axially in the crown 724 of the fixed part 72.

Skirt 744 is capable of sliding into the intermediate portion 64 of the sleeve, the external diameter of the skirt 744 being less than the internal diameter of the intermediate portion 64.

The tightening device 40 also includes an immobilizer bit 76 and an ultrasonic transducer 88, housed inside the immobilizer support 46. In the embodiment shown, the tightening device 40 also comprises: an elastic member such as a compression spring 90; and a cable 92.

The bit 76 consists of a front face 78 and a back face 80, both of which are flat and perpendicular to the X-axis. The immobilizer bit 76 includes an anti-rotation interface 82, adapted to engage the recess 326 of screw 32, the free end of which is the front face 78. Interface 82 can be a cylinder with a hex base if the recess 326 is hexagonal, or a cylinder with a multilobed base if the recess is multilobed. Such a bit is for example described in the applicant's patent FR2967735.

Preferably, the material of the bit 76 is the same or similar to the material of the screw 32. Alternatively, the acoustic impedance—or density—of the bit is the same as or close to the acoustic impedance—or density—of the screw.

Acoustic impedance is the product of the velocity of the wave in the material and the density of the material. Too large a difference in acoustic impedance can cause a reflection of part of the waves at the interface of the bit and the screw, thus a loss of signal.

For example, if the screw is made of TA6V titanium alloy, the bit will preferably be made of TA6V titanium alloy, or a similar alpha-beta type titanium alloy.

In the embodiment shown, the interface 82 is connected by a conical portion to a cylindrical portion of enlarged diameter, in which an annular groove 84 is made. This groove is depicted with a V-section on the figures, but it can take on all kinds of shapes.

The immobilizer bit 76 is attached to the movable part 74 of the immobilizing support by a pin 86, inserted into a hole in the movable part 74 and lodged in the annular groove 84.

The ultrasonic transducer 88 is an ultrasonic transceiver, attached to the back face 80 of the bit 76. An electrical interface 87 is realized, for example, with a Microdot, SMA or SMB type connector. The transducer is connected via the electrical interface by cable 92 to a power supply (not shown) and functions as a transmitter, converting the electrical energy into mechanical oscillations to produce ultrasound transmitted into screw 32 via the immobilizer bit 76. The transducer 88 also functions as a receiver, converting a reflected ultrasonic wave into an electrical signal, transmitted via cable 92 to an analog or digital electronic device such as a processor (not shown), capable of processing the received electrical signal to calculate the tension in the screw. The transducer is for example a piezoelectric sensor, preferably in PZT4 or PZT8. The electronic device can be integrated into the tool, or can be remoted.

As a variant shown in FIG. 3A, the immobilizer bit 76A comprises a front face 78A and a hollowed part 85 comprising a flat bottom 80A, perpendicular to the X-axis. The ultrasonic transducer 88 is fixed on the flat bottom 80A, inside the recess of the immobilizer bit 76A. The integration of the transducer and the electrical interface 87A inside the bit ensures their protection.

Preferably, the transducer and the electrical interface are protected by a cover 85A, e.g. made of plastic, closing the hollowed part 85. Optionally, the hollowed part can be filled, e.g. with epoxy conductive resin, to adjust the damping and bandwidth of the transducer.

Advantageously, the flat bottom 80A is placed as close as possible to the front face 78A to avoid deteriorating the quality of the transmission of ultrasonic waves, due to the geometry of the bit and/or the thickness of the material between the transducer and the front panel, the latter being able to resonate and pollute the useful measurement in the screw 32.

Whether the transducer 88 is fixed on the back side 80 of the 76 bit or fixed on the bottom 80A of the bit 76A, it is preferable that the immobilizing bit 76 or 76A has no surface with a half angle equal to 45°, to avoid total reflection of the waves towards the transducer 88. Outer surfaces at an angle to the X-axis can be ridged or knurled to destroy the incident wave and limit its reflection in the body of the immobilizing bit 76, 76A.

It is also preferable that the body of the bit 76, 76A is sized so that the resonance of the bit is distinct from the resonance of the screw 32, so that it can be easily discriminated during the measurement.

The assembly consisting of the transducer 88 and the immobilizer bit 76, 76A is thus attached to the movable part 74 of the immobilizing support, via the pin 86.

Preferably, a dry coupling 79 is inserted between the front side 78 of the bit and the bottom 328 of the screw recess, in order to improve sound transmission. Couplant 79 can be for example a sheet of tin, silver, copper or an elastomer coupling material such as Aqualene, developed by Innovation Polymers, Canada.

Preferably, the coupling agent is tin deposited on the front side 78, 78A of the immobilizer bit 76, 76A. Tin is a relatively soft metal that compensates for the surface defects of screw 32. In addition, its acoustic impedance is compatible with inspection on a metal material and promotes the passage of ultrasound from the transducer 88 to the screw 32.

The coupling agent is preferably between 0.0175 mm and 0.6 mm. The foil or material can be deposited by dry or wet conditions, by welding or soldering, or can also be glued, to the front side of the bit.

The compression spring 90 is arranged in the crown 724 of the fixed part 72 of the support 46. It rests axially on the one hand on the flange 742 of the movable part 74 of the support 46, and on the countersink 726 of the fixed part 72 of the support on the other. The flange guides the assembly formed by the transducer 88 and the immobilizer bit 76 parallel to the axis of revolution X of the tightening device 40. The guidance thus ensures that the ultrasonic waves are emitted in the X-axis of the tightening device.

The assembly formed by the immobilizer bit 76, 76A and the transducer 88 is thus movable in the axial direction X between a first position, in which the spring is relaxed (FIGS. 3 and 4), and a second position, in which the spring is compressed (FIG. 5) and capable of imparting a predetermined pressure to the immobilizer bit 76, 76A. The assembly formed by the immobilizer bit 76, 76A and the transducer 88 is fixed in rotation with respect to the body 42.

Preferably, the tightening device is suitable for use with a fastener with a nut with an axial stop, e.g. a 34a, 34b, 34c or 34d nut shown in FIG. 7a, 7b, 7c or 7d. In the remainder of the description, each tightening device 40a, 40b, 40c and 40d comprises respectively a counter-stop device 94a, 94b, 94c and 94d cooperating with the axial stop 37a, 37b, 37c, 37d of the nuts, the axial stop and the counter-stop devices being capable of limiting a relative axial movement between the nut and the tightening device.

Where the axial stop 37 of a nut comprises a portion in depression, such as a groove 37a or a cut-out 37b, 37c, the counter-stop device 94 preferentially comprises at least one movable blocking element 114a, b, c radially, said at least blocking element being adapted to fit into said at least depression portion of the nut.

Advantageously, the counter-stop device 94 includes as many blocking elements 114a, b, c as there are depression portions of the nut.

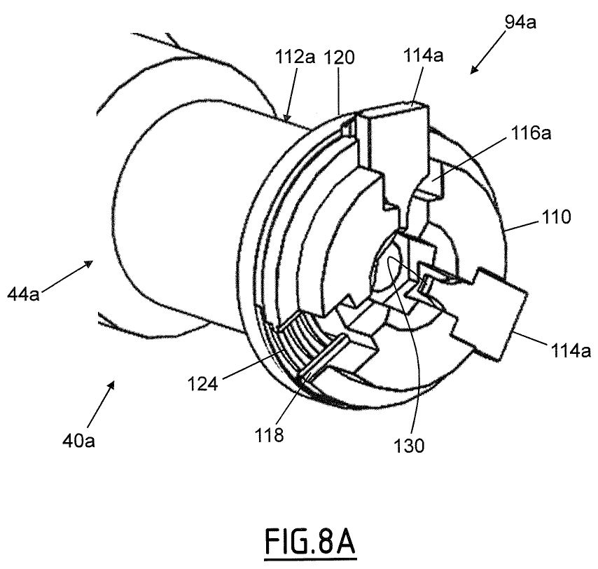

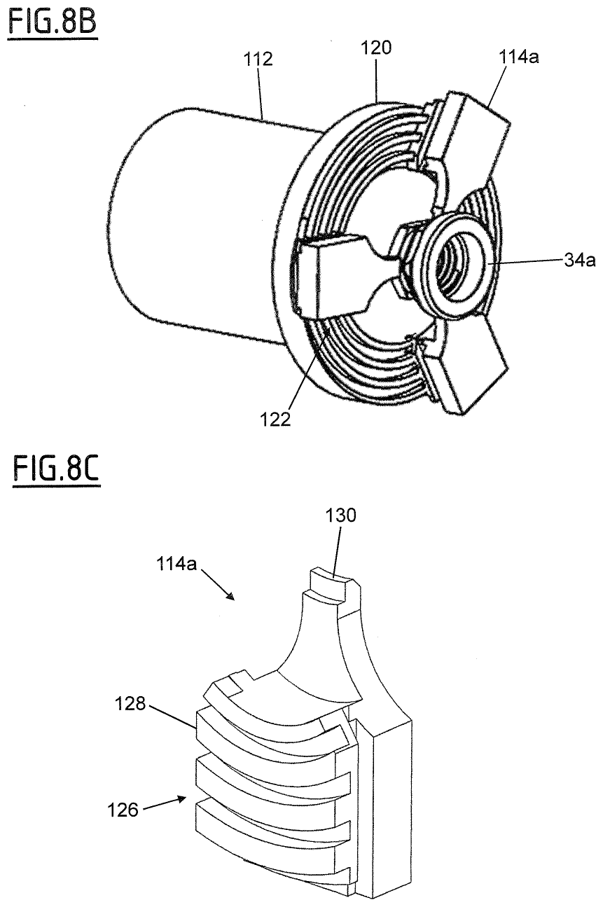

FIG. 8a shows tightening device 40a including a counter-stop device 94a. The 94a counter-stop device comprises: a first flange 110, a ring 112a and three blocking elements 114a, of which only two are shown for clarity.

The first flange 110 is located at the first end 54a of the socket 44a, and in this example, is an integral part of the socket 44a. Apart from this flange, the socket 44a is identical to the socket 44 of the tightening device 40 described above. The first flange 110 could alternatively be an element attached to the socket 44. The first flange 110 extends radially outward and has three notches 116a extending in the radial direction, in a thickness of the first flange. In the embodiment of FIG. 8a, the three notches are arranged at 120°. Each notch advantageously includes lateral tabs 118, which have a function of retaining and guiding a blocking element 114a.

The ring 112a is arranged around the socket 44a. The ring 112a is free in rotation around the socket 44a, and fixed in translation with respect to the said socket. The ring 112a includes a second flange 120, configured to rest against the first flange 110. A radial surface 122 of the said second flange is provided with a helical groove 124, the center of which is in the center of the second flange.

Each blocking element 114a is capable of sliding in the radial direction in each notch 116a of the first flange 110. As shown in FIG. 8c, a radial surface 126 of a blocking element 114a, intended to rest against the helical groove 124 of the second flange 120, is provided with a set of curved grooves 128 suitable for cooperating with the said helical groove. The end portion 130 of a blocking member 114a is capable of cooperating with the depression portion 37a of nut 34a, as shown in FIG. 8b. Preferably, the end portion 130 has a complementary form of the groove 37a. The end portion 130 and the groove 37a each have a surface extending substantially in a radial plane. The engagement of these surfaces limits the relative axial movement between the nut 34a and the tightening device 40a.

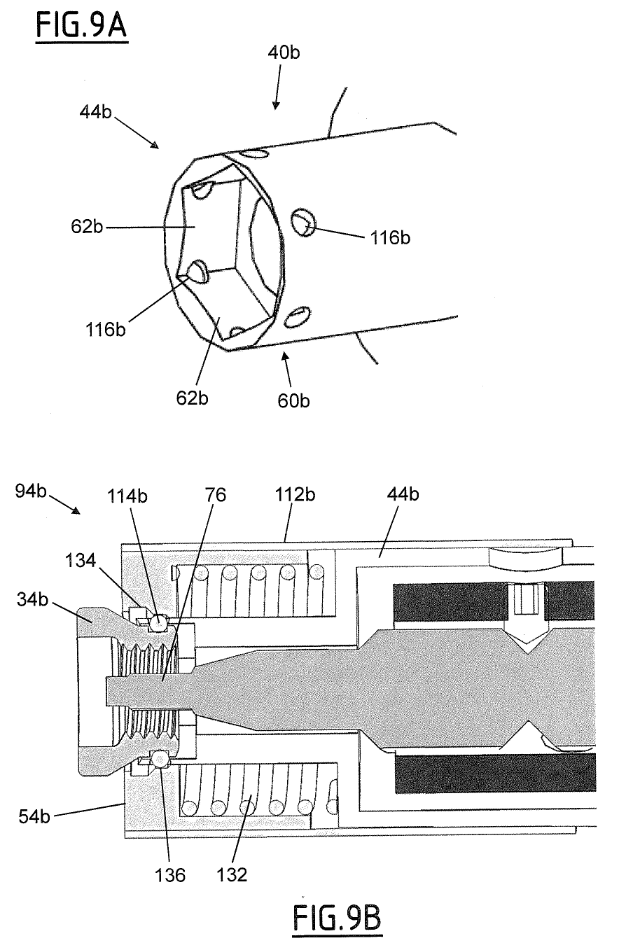

In a second embodiment of a tightening device 40b, the socket 44b shown in FIG. 9a is suitable for cooperating with a nut 34b. The socket 44b consists of six holes 116b extending radially and passing through the thickness of the distal portion 60b of the socket 44b. Each hole 116b is arranged on an edge between two adjacent flat faces 62b of the distal portion 60b. Other arrangements are possible if the depression portions 37b of the nut 34b are arranged differently, or elsewhere. The number of through-holes may also vary, depending on the number of portions in depressions 37b of the nut.

The counter-stop device 94b, shown in FIG. 9b, comprises: a ring 112b, moving elements 114b in the form of balls, and an elastic element 132.

The ring 112b is arranged around the distal portion 60b of the socket 44b. The ring 112b has a first internal surface capable of sliding axially on the distal portion 60b of the socket, the internal surface comprising a first circumferential groove 134 having a first diameter, and a second circumferential groove 136 having a second diameter, less than the first diameter.

Each ball 114b is movable in each radial hole 116b, between a protruding position inside the socket 44b, and a retracted position in which each ball 114b is contained in the second circumferential groove 136 of the ring (FIG. 9b).

The elastic element 132 is for example a compression spring. It is arranged around the socket 44b and inside the ring 112b. The spring 132 rests on the one hand against an inner shoulder of the ring 112b, and on the other hand against an inner shoulder of the socket 44b. When the tightening device is in the free state, i.e. it does not cooperate with the nut 34b, the spring 132 tends to push the ring away from the socket: the first circumferential groove 134 is then arranged in front of the holes 116b so that the balls 114b are contained in the first circumferential groove 134, and do not interfere with the insertion or removal of the nut in the socket.

In the position shown in FIG. 9, spring 134 is in a compressed state, so that each ball 114b is housed in a cutout 37b of the nut. The surfaces in contact in the radial plane of each ball with each cut-out limit the axial movement of the nut 34b with respect to the tightening device 40b.

It should be noted that the tightening device 40b is suitable for a nut 34a or 34c, the number of balls and their location having to be adapted to the geometry of the nut.

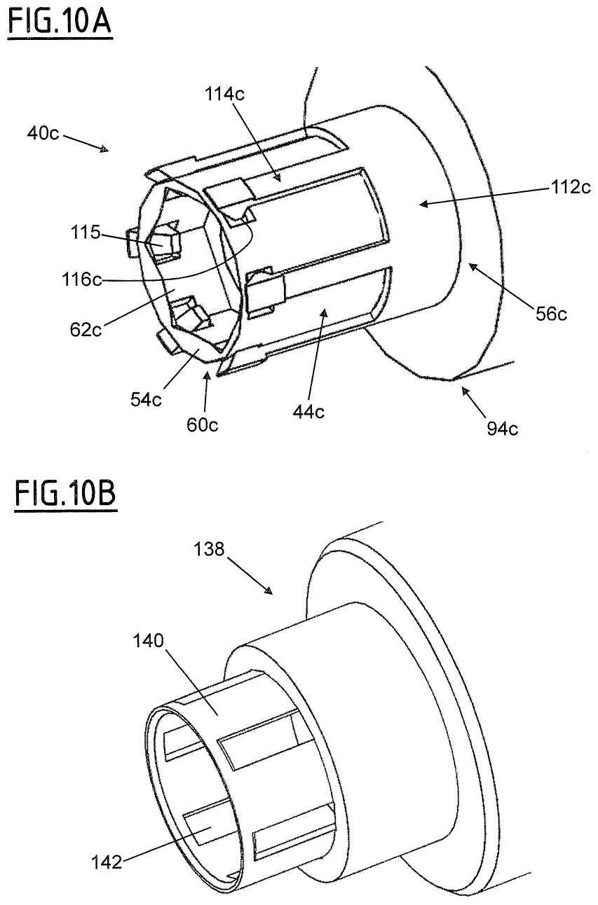

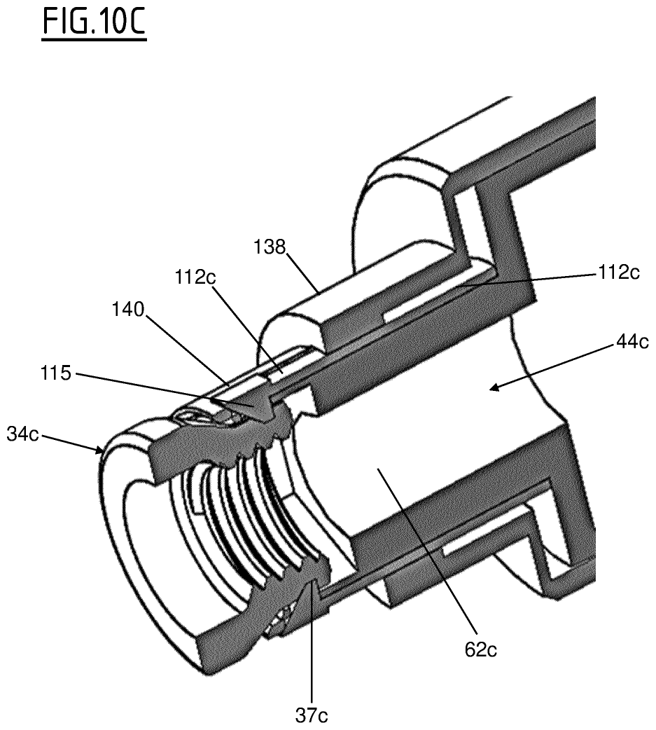

In a third embodiment of a tightening device 40c, the socket 44c shown in FIG. 10a is suitable for cooperating with a nut 34b or 34c. The distal portion 60c of the socket 44c is equipped with six rectangular-shaped holes 116c, each hole passing through the thickness of the distal portion 60c. Each hole 116c is arranged on an edge between two adjacent flat faces 62c of the distal portion 60c.

The counter-stop device 94c comprises: a ring 112c arranged around the distal portion 60c of the socket 44c, the ring 112c having at one end close to the first end 54c of the socket 44c, at least one tab 114c extending axially. Each tab is radially flexible and is provided at one end with a protrusion 115 suitable for penetrating a hole 116c in the socket. FIG. 10a shows a holding position, in which the socket 112c comprises six tabs114c, the protrusions 115 of which penetrate the six holes 116c of the socket 44c.

The counter-stop device 94c also includes a second ring 138 arranged around the ring 112c, shown in FIG. 10b. The second ring 138 comprises a tubular portion 140 pierced by six through holes 142, each through hole being configured to receive the protrusion 115 and an axial portion of each tab. The second ring 138 is suitable for axial sliding on the socket 44c. It is configured so that axial movement towards the second end 56c of the socket 44c results in a radial outward displacement of each protrusion 115. The second ring 138 allows the tabs 114c to be lifted and the nut 34b or 34c to be disengaged from the distal portion 60c of the socket 44c. The second ring 138, for example, can be operated manually.

In the holding position in FIG. 10c, the socket 44c includes six through holes 116c, the socket 112c includes six tabs 114c, whose protrusions 115 penetrate into: the six holes 116c of the socket 44c, the through holes 142 of the second socket, and the cutouts 37c of the nut 34c.

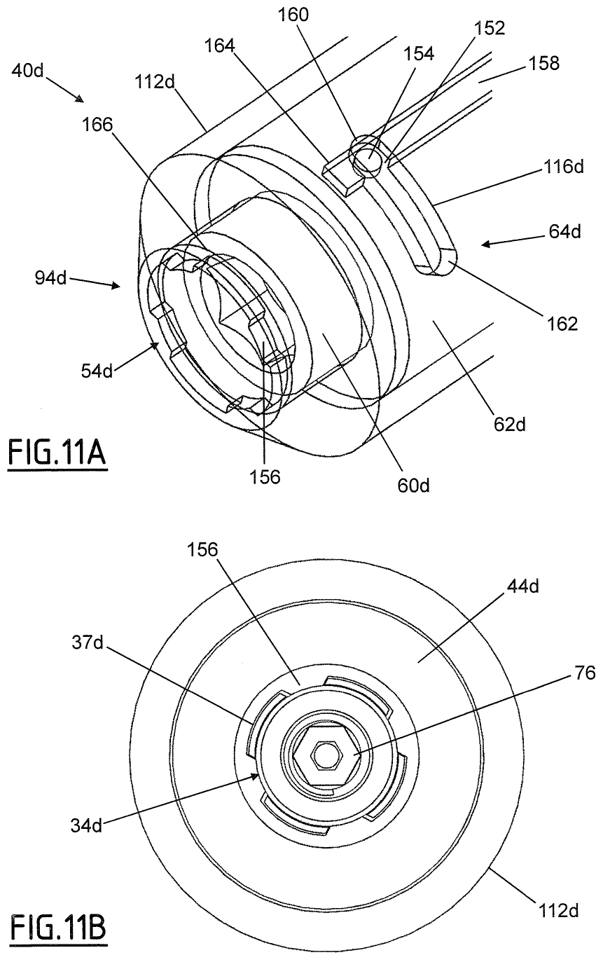

In a fourth embodiment shown in FIG. 11a, the tightening device 40d is adapted to cooperate with a nut 34d. The tightening device 40d comprises a socket 44d comprising a distal portion 60d identical to the distal portion 60 of the socket 44, and an intermediate portion 64d provided with two holes 152. Each hole 152 receives a pin 154 extending radially outwards, projecting from the surface of the socket 44d. In this example, the holes, and consequently the pins, are arranged at a 180° position around the circumference of the socket 44d.

The counter-stop 94d device includes a ring 112d arranged around the distal and intermediate portions 60d, 64d of the socket 44d. The ring 112d is tubular in shape, with one end close to the first end 54d of the socket 44d having crenellations 156 extending radially inward. Preferably, the ring 112d has as many crenellations 156 as the nut 34d has protruding portions 37d. As shown in FIG. 11b, the crenellations are shaped and sized to interface with the protruding portions 37d of the nut.

The ring 112d additionally includes: two through holes 116d and two grooves 158 interfacing with the pins 154. Each through hole extends circumferentially over a portion of ring 112d arranged around an intermediate portion 64d of the socket 44d. Each through hole extends between a first end 160 and a second end 162. In the position in FIG. 11a, each pin 152 is arranged against an end 160 of a through hole 116d. Each through hole 116d is designed to allow the ring 112d to rotate on the pins 152, between the two ends 160, 162.

Each groove 158 extends axially over an internal surface of the ring, up to a portion of end 164 orthogonally cutting the first end 160 of a through hole 116d. The size and shape of each groove is designed to allow the ring 112d to slide axially over the pins 154 when mounting the ring 112d to the socket 44d. A method of tightening fasteners 32, 34, 34a, 34b, 34c, 34d in two elements 22, 24 by means of devices 40, 40a, 40b, 40c and 40d will now be described. This process allows the fastener to be tightened while controlling the tightening tension induced in the screw by tightening the nut on the screw and the two elements.

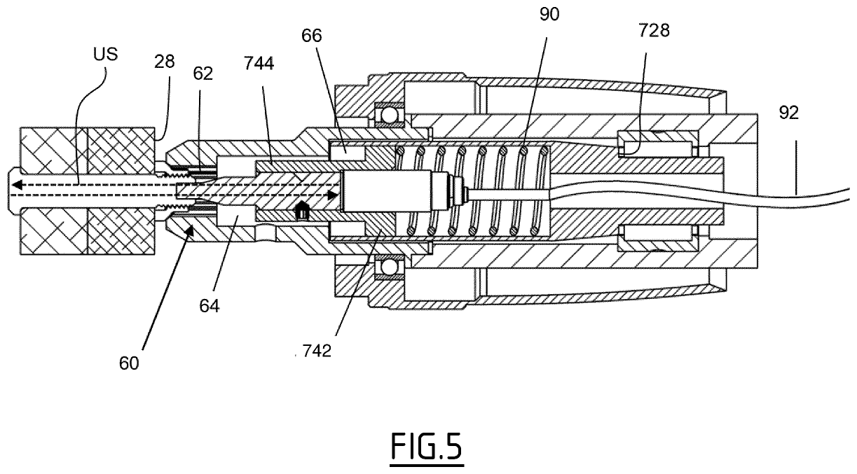

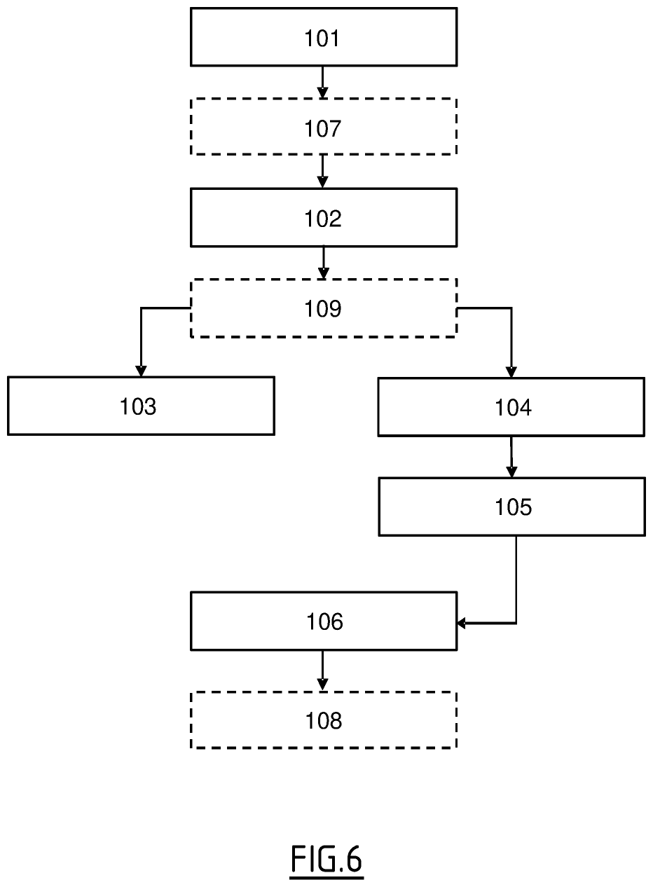

Reference is now made to FIG. 6 showing the steps of the process 100 for tightening a fastener, implemented by means of a tightening device 40 described above.

In step 101, screw 32 is inserted into hole 20 of elements 22, 24 previously described, until one end of the threaded portion 324 emerges from element 24. Nut 34, 34a, 34b, 34c or 34d is placed on the said end of the threaded portion 324, engaging a few threads, as shown in FIG. 3.

Then, during a 102 step, the tightening device 40, 40a, 40b, 40c and 40d is brought close to the fastener so that the immobilizer bit 76, 76A engages the recess 326 of screw 32. Displacement of device 40, 40a, 40b, 40c, and 40d is continued until the front face 78, 78A of the bit contacts the bottom 328 plane of the recess, and the distal portion 60, 60a, 60b, 60c, or 60d of the socket contacts the drive surfaces 36 of the nut, as shown in FIG. 4.

In this position, the X-axis of the tightening device is merged with the A-axis of the fastener; and the flat front 78, rear 80 or the bottom 80A of the bit 76, 76A, the flat bottom 328 of the recess and the front surface 330 of the head end of the screw are parallel to each other and perpendicular to the axes of revolution X and A combined. The flange 742 is moved axially, away from the shoulder 70, due to the engagement between the screw and the immobilizer.

The front face 78, 78A of the bit is kept in contact with the bottom 328 plane of the recess with a pressure predetermined by the spring stiffness 90.

Due to the engagement of the anti-rotation surfaces of the bit and screw, the assembly formed by the ultrasonic transducer 88, the immobilizer bit 76, 76A and the screw 32 is fixed in rotation. After this step, if the nut has an axial stop and the tightening device includes a counter-stop device, as described above, an optional stress step 109 is applied to the nut 34a, 34b, 34c and 34d to limit an axial relative movement of the nut with respect to the socket 44, a resultant of said stress axially opposing the pressure imparted on the screw by the immobilizer bit 76, 76A.

When the tightening process 100 is implemented on a fastener with a nut 34a by means of a tightening device 40a fitted with a counter-stop device 94a, the ring 112a is then rotated around the socket. As a result of the engagement of the curved grooves 128 of each moving member 114a with the helical groove 124 of the second flange 120, each moving element 114a moves radially inward, until the inner peripheral surface 130 of each moving element enters the circumferential groove 37a of nut 34a. Since the thread of the nut 34 is in contact with the thread of the screw 32, the engagement of the end portion 130 of the moving element in the groove 37a of the nut is axially opposed to the pressure imparted on the screw by the immobilizing end 76.

When the tightening process 100 is implemented on a fastener with a nut 34b by means of a tightening device 40b fitted with a counter-stop device 94b, the ring 112b is pulled axially towards the second end of the socket 44b so that the balls are contained in the first circumferential groove 134 without interfering with the insertion of the nut into the socket 44d. The ring 112b is then released and pushed back to the first end 54b of the socket. The balls are then forced to take their place in the second circumferential groove 136, in the radial holes 116b of the socket 44b and the cutouts 34b of the nut. Nut 34b is thus trapped in tightening device 40b.

When the 100 tightening process is implemented on a fastener with a 34c nut using a tightening device 40c fitted with a counter-stop device 94c, the insertion of the nut 34c into the socket 44c pushes the protrusions 115 of the flexible tabs 112c radially outward, which automatically return to the holes 116c of the socket 44c and the cutouts 37c of the nut once the nut is inserted into the distal portion 60c of the socket 44c. The nut 34c is thus trapped in the tightening device 40c.

When the tightening process 100 is carried out on a fastener with a nut 34d by means of a tightening device 40d fitted with a counter-stop device 94d, the nut 34d is inserted into the distal portion 60d of the socket 44d until the projecting portions 37 of the nut are contained in a housing 166 between slots 156 of the ring 112d and the end 54d of the distal portion 60d of the socket 44d. The ring 112d is rotated around the socket 44d to axially oppose the slots 156 of the socket 44d and the protruding portions 37d of the nut 34d. During this rotational movement, the through holes 116d rotate so that each pin 154 comes to rest against the second end 162 of each through hole 116d. Any unwanted rotational movement between the socket 44d and the ring 112d is thus blocked, ensuring the engagement of the slots 56 of the socket with the protruding portions 37 of the nut.

Due to the engagement of the axial stop of the nut and the counter-stop device, the front face 78, 78A of the bit is kept in contact with the bottom 328 plane of the recess with a constant pressure, predetermined by the stiffness of the spring 90. The advantage of maintaining constant pressure is to ensure that signals are transmitted and received without weakening or loss during the advance of the nut over the screw thread, when the nut 34a, 34b, 34c or 34d is rotatively driven by the socket 44a, 44b, 44c or 44d.

Then, in a step 103, the socket 44 is rotated along the X-axis with respect to the body 42. As the screw is locked in rotation with respect to the body by means of the immobilizer bit 76, the nut 34, 34a, 34b, 34c is screwed onto the threaded portion 324 of the screw.

During a step 104, simultaneous with step 103, US ultrasound is emitted by the transducer 88 through the immobilizer bit 76 and the screw 32 (FIG. 5). The immobilizer bit 76 thus ensures the propagation of the waves transmitted by the transducer to the fastener via the bottom 328 of the plane recess.

The US ultrasound propagates through the screw, reflects off the front surface 330 of the screw head, and returns to the transducer 88 as an echo. The transducer 88 transforms the acoustic energy received into electrical energy, and transmits this energy in the form of an electrical signal to an electronic device remote via cable 92.

In a step 105, the external electronic device processes the received electrical signal to determine a tension in the screw.

According to one embodiment, the tension in screw 32 is determined from the deformation of the screw and Young's modulus via Hooke's law. The deformation of the screw is obtained from measurements of the time of a round trip of a wave, and compared to a pre-recorded deformation value corresponding to a predefined threshold tension. The Young's modulus E is a constant associated with the material of screw 32.

Alternatively, the tension in the screw 32 is determined from the measurement of the variation in the impedance of the screw, via the measurement of the resonant frequency which depends on the stress in the screw.

Alternatively, other methods for calculating the screw tension can be used, such as one of the methods described in the publication “Review of Bolted Connection Monitoring” by Tao Wand et al., which can be accessed at the URL http://dx.doi.org/10.1155/2013/871213.

Then, during a step 106, the electronic device emits a signal, or displays an indication that the induced tension is equal to the predefined threshold tension, so that an operator installing the fastener stops tightening the nut. Alternatively, the electronic device is configured to control the tightening process and stop it as soon as the calculated tension value equals the predefined threshold tension, without human intervention.

The preset threshold tension can be the tension that was predetermined by calculation when the fastener was designed, or a tension slightly lower than this value to take into account the calculation time of the electronic device and the time required to display the stop instruction, during which time the nut is rotated by the tightening device.

Then the tightening device 40 is disengaged from screw 32 and nut 34, 34a, 34b, 34c, 34d and can be used to install another fastener.

To disengage the nut 34a from the tightening device 40a, the ring 112a is then rotated around the socket in the opposite direction. Each moving element 114a moves radially outward, disengaging from the circumferential groove 37a of the nut 34a.

To disengage the nut 34b from the 40b clamp, the ring 112b is pulled axially to the second end of the socket 44b so that the balls are contained in the first circumferential groove 134, and allow the socket 44d to be removed.

To disengage the nut 34c from the clamp 40c, the second ring 138 is pulled axially to the second end of the socket 44c to lift the protrusions 115 from the nut cutouts 37d.

To disengage the nut 34d from the tightening device 40d, the ring 112d is rotated in the opposite direction so that each pin 154 ends up at one end 160 of each through home 116d.

Optional steps can be incremented to the previously described steps to improve tightening tension control. These steps are shown in discontinuous lines in FIG. 6.

Thus, during an optional step 107, inserted between steps 101 and 102, a dry couplant can be inserted between the front face of the bit and the flat bottom 328 of the screw recess 32 so as to cover the bottom 328 plane of the recess. This couplant can be useful to ensure better transmission of waves in the screw 32.

Alternatively, this couplant can be a liquid couplant, such as water, or a gel couplant, poured into the recess.

During an optional step 108, after step 106, the calculated tension value and the fastener reference can be stored in an external database. This recording may be necessary to verify the tension installed in the fastener over time.

The tightening process described above has the advantage of installing a recessed fastener without additional delay compared to a prior art fastener, while reliably and repeatably controlling the tension in the screw.

The system implemented also allows for a gain in productivity. Indeed, the device according to the invention makes it possible to gain in precision during control and/or measurements, and thus to eliminate additional verification steps in case of doubt about the reliability of a measurement.

The tension in the screw can be measured over time using the tightening device described above by disengaging socket 44, as long as the installed tension of the measured fastener has been recorded in a database, during additional step 108.

1. A method of tightening a fastener comprising a screw and a nut;
the screw comprising: a head having a flat front surface; and a threaded portion, one end of said threaded portion having an axially arranged recess, said recess comprising a flat bottom and a non-circular cross-section;
the nut including a drive surface;
characterized in that the method comprises the following steps:
a. Inserting the screw into a hole passing through at least two elements until the end of the threaded portion emerges from the members, and placing the nut on the emergent end of the threaded portion of the screw;
b. Engaging an immobilizer bit in the recess, until a front face of the bit contacts the flat bottom of said recess, said immobilizer bit comprising a complementary shape of the non-circular section of said recess;
c. Rotating the nut on the threaded portion of the screw while rotating the immobilizer bit and screw;
d. Exciting an ultrasonic transducer disposed on a rear face of the bit, the ultrasonic transducer being capable of generating ultrasonic waves in the bit and the screw when the bit is engaged in the screw recess;
e. Receiving the ultrasonic waves reflected from the flat front surface of the screw head and processing of the received ultrasonic waves to calculate a tension in the screw;
f. Stopping the rotation of the nut when the tension in the calculated screw equals a predefined threshold tension.

2. The method of tightening according to claim 1, wherein, at the step of engaging the bit into the screw recess, the immobilizer bit is engaged with a predetermined pressure on the screw via at least one elastic member.

3. The method of tightening according to claim 2, wherein the nut is rotated by a socket and wherein, after step (b) and before step (c), a stress is applied to the nut to limit an axial relative motion of the nut with respect to the socket, a resultant of said stress axially opposing the pressure imparted on the screw by the immobilizer bit.

4. The method of tightening according to claim 1, wherein a dry coupling is inserted between the front face of the bit and the flat bottom of the recess prior to the excitation of the transducer.

5. The method of tightening according to claim 1, wherein a liquid coupling or gel is poured into the recess prior to excitation of the transducer.

6. A tightening device configured for carrying out a tightening method according to claim 1, a screw and a nut in a hole passing through at least two elements;
the screw comprising: a head having a flat front surface; and a threaded portion; an end of said threaded portion having an axially arranged recess, said recess comprising a flat bottom and a non-circular cross-section;
the tightening device including:
a body;
a fixed immobilizer bit rotating and axially movable with respect to the body, the bit comprising: an anti-rotation interface configured to engage with the non-circular section of the screw recess; a flat front face, configured to contact the flat bottom of the recess; and an opposite rear face;
a socket that rotates in relation to the body and is configured to drive the nut in rotation;
an ultrasonic transmitter, arranged on the rear face of the bit, the ultrasonic transmitter being capable of generating ultrasonic waves in the bit and in the screw when the front face of the bit is in contact with the flat bottom of the recess of the screw; and
an ultrasound receiver, arranged on the rear face of the immobilizer bit, the ultrasound receiver being able to convert a reflected ultrasound wave into an electrical signal.

7. The tightening device according to claim 6, wherein the immobilizer bit comprises a hollowed part having a flat bottom, wherein the ultrasonic receiver is disposed on said flat bottom.

8. The tightening device according to claim 6, wherein the bit has a density equal to or close to a density of the screw.

9. The tightening device according to claim 6, wherein the bit comprises a tin deposit on the front face.

10. The tightening device according to claim 6, further comprising an immobilizer support, said support comprising: a fixed part in relation to the body; and a movable part, capable of sliding axially inside the fixed part; the ultrasonic transmitter and receiver and the immobilizer bit being integral to said movable part.

11. The tightening device according to claim 10, comprising a compression spring disposed in the immobilizer support, the spring resting on the movable part and on the fixed part of the immobilizing support.

12. The tightening device according to claim 6, wherein: the nut comprises an axial stop; and the tightening device comprises a counter-stop device cooperating with the axial stop of the nut, the axial stop and the counter-stop device being able to limit a relative axial movement between the nut and the tightening device.

13. The tightening device according to claim 12, wherein the axial stop of the nut comprises at least one depressed portion with respect to an outer surface of the nut, and the counter-stop device comprises at least one movable blocking member radially, said at least blocking member being adapted to fit into said at least depressed portion of the nut.

14. The tightening device according to claim 13, wherein the axial stop of the nut comprises at least one groove portion or at least one cut-out.

15. The tightening device according to claim 12, wherein the counter-stop device further comprises:
a. a first flange disposed at a free end of the socket, said first flange having at least one notch extending radially into a thickness of the first flange;
b. a ring arranged around the socket, said ring being free in rotation around the socket and fixed in translation with respect to the socket, said ring comprising a second flange resting against the first flange, a radial surface of said second flange being provided with a helical groove; and
c. at least one movable element capable of sliding into the at least one notch of the first flange, a radial surface of the notch being provided with at least one curved groove capable of cooperating with the helical groove of the second flange, an internal peripheral surface of the movable element being capable of cooperating with the depressed portion of the nut.

16. The tightening device according to claim 12, wherein the socket comprises at least one radial through-hole radial; the tightening device also comprising a ring arranged around the socket; the at least one blocking element being movable in at least one radial hole between a protruding position inside the socket, and a retracted position in which at least one blocking element does not interfere with the insertion of the nut into the socket.

17. The tightening device according to claim 16, wherein the ring has a first internal surface capable of sliding axially along the socket, the inner surface comprising a first circumferential groove, at least one blocking element being contained in the first circumferential groove of the ring in the retracted position.

18. The tightening device according to claim 16, wherein the ring has an inner shoulder, the tightening device comprising an elastic member housed in a space between the socket and the socket, said spring resting on the one hand against the inner shoulder of the socket and on the other hand against an outer shoulder of the socket.

19. The tightening device according to claim 16, wherein the ring is provided with at least one radially flexible tab extending axially, said tab being provided at one end with a protrusion capable of penetrating the at least one radial through hole of the socket.

20. The tightening device according to claim 19, further comprising a second ring arranged around the ring, the second ring comprising a tubular portion pierced with at least one through hole, each through hole being configured to receive at least the protrusion of a tab, the second ring being capable of sliding axially over the socket, and being configured so that axial movement in the direction of a second end of the socket results in an outward radial displacement of each protrusion.

21. The tightening device according to claim 6, wherein the nut comprises at least one stop extending radially outward, the counter-stop device comprising a ring arranged around the socket, said ring comprising at least one counter-stop, said stops and counter-stops being configured so that a relative rotation of the ring with respect to the nut axially opposes said stops and counter-stop.
